(19) United States
(12) Patent Application Publication
(10) Pub. No.: US 2024/0082756 A1
(43) Pub. Date: Mar. 14, 2024

(54) Filter System with a Filter Element and a Safety Assembly, a Safety Assembly, and a Filter Element

(71) Applicant: MANN+HUMMEL GmbH, Ludwigsburg (DE)

(72) Inventor: Jan SVOBODA, Cíhalín (CZ)

(21) Appl. No.: 18/510,751

(22) Filed: Nov. 16, 2023

Related U.S. Application Data
(63) Continuation of application No. PCT/EP2022/063643, filed on May 19, 2022.

(30) Foreign Application Priority Data
May 21, 2021 (EP) 21175337.1

(51) Int. Cl. B01D 29/96; B01D 29/21

(52) U.S. Cl. CPC B01D 29/96; B01D 29/213; B01D 2201/291; B01D 2201/347; B01D 2201/4007; B01D 2201/4046

(57) ABSTRACT

The invention relates to a filter system comprising a housing and a filter element being accommodated in the housing, wherein a safety assembly is arranged inside the housing, having a blocking mode and an unblocking mode depending on an axial and/or rotational position of the filter element in the housing and being configured to provide access of a sealing structure of the filter element to a sealing area of a housing cover in the unblocking mode and to block access of the sealing structure to the sealing area in the blocking mode when the sealing structure of the filter element is moved towards the sealing area. The invention further relates to a safety assembly for a filter system and a filter element.

### TECHNICAL FIELD

The invention relates to a filter system with a filter element and a safety assembly, and a safety assembly and a filter element for such a filter system.

### PRIOR ART

Such filter systems or filter elements are used for filtering gaseous or liquid fluids. In motor vehicles and industrial engines such filter systems are used for filtering especially fuel, especially diesel fuel or gasoline, motor oil or hydraulic oil.

US 20150033689 A1 discloses a filter system for filtering fluids which has a housing, an inlet, and an outlet. A filter element is arranged inside the housing. A cover closes the housing and provides access to the filter element inside the housing. A securing device prevents the housing from being closed by the cover when the filter element is missing. The filter element has at least one filter element guide path section. The housing or the cover has a rim area with at least one rim guide path section. The filter element guide path section and the rim guide path section supplement one another to a guide path. The securing device comprises at least one securing element arranged on the cover or the housing. The securing element is guided on the guide path when a closing movement is carried out for closing the housing by the cover.

### DISCLOSURE OF THE INVENTION

It is an object of the invention to provide a filter system with a filter element and a safety assembly which allows for a reliable and correct mounting of the filter element.

Another object of the invention is to provide a safety assembly for such a filter system.

Another object of the invention is to provide a filter element for such a filter system.

The first object is achieved by a filter system comprising a housing with a housing head and a housing cover, a fluid inlet and a fluid outlet and a filter element being accommodated in the housing, the filter element comprising a center pipe having a longitudinal direction and being surrounded by a filter bellows, the filter bellows comprising an end cap at one or both of its end regions, the filter element further comprising a sealing structure, particularly a gasket, at the end cap, wherein a safety assembly is arranged inside the housing, having a blocking mode and an unblocking mode depending on an axial and/or rotational position of the filter element 10 in the housing and being configured to provide access of the sealing structure of the filter element to a sealing area of the housing cover in the unblocking mode and to block access of the sealing structure of the filter element to the sealing area in the blocking mode when the sealing structure of the filter element is moved towards the sealing area, the safety assembly having a first section arranged at the housing and a second section arranged at the filter element, the first and second sections comprising at least one blocking element and at least one unblocking element configured to cooperate with the at least one blocking element, the at least one blocking element comprising an activation surface and the at least one unblocking element comprising a cam for pushing the activation surface in a radial direction when a contact between the cam and the activation surface is established.

Another object is achieved by a safety assembly for a filter system, the filter system comprising a filter element and a housing, having a blocking mode and an unblocking mode depending on an axial and/or rotational position of the filter element in the housing and being configured to provide access of a sealing structure of the filter element to a sealing area of the housing in the unblocking mode and to block access of the sealing structure of the filter element to the sealing area in the blocking mode when the sealing structure of the filter element is moved towards the sealing area, having a first section arranged at the housing and a second section arranged at the filter element, the first and second sections comprising at least one blocking element and at least one unblocking element configured to cooperate with the at least one blocking element, the at least one blocking element comprising an activation surface and the at least one unblocking element comprising a cam for pushing the activation surface in a radial direction when a contact between the cam and the activation surface is established.

Another object is achieved by a filter element for a filter system, comprising a center pipe having a longitudinal direction and being surrounded by a filter bellows, the filter bellows comprising an end cap at one or both of its end regions, and comprising a section of a safety assembly with either at least one unblocking element or at least one blocking element configured to cooperate with either the at least one blocking element or the at least one unblocking element of a first section of the safety assembly, the filter element further comprising a sealing structure, particularly a gasket, on one of its end regions, wherein the at least one blocking element and the at least one unblocking element are configured to provide access of the sealing structure to a sealing area of a housing cover of the filter system in the unblocking mode and to block access of the sealing structure to the sealing area in the blocking mode when the sealing structure is moved towards the sealing area.

Favorable embodiments and advantages of the invention are apparent from the further claims, the description and the drawings.

In a first aspect of the invention a filter system is proposed, comprising a housing with a housing head and a housing cover, a fluid inlet and a fluid outlet and a filter element being accommodated in the housing, the filter element comprising a center pipe having a longitudinal direction and being surrounded by a filter bellows, the filter bellows comprising an end cap at one or both of its end regions, the filter element further comprising a sealing structure, particularly a gasket, at the end cap. A safety assembly is arranged inside the housing, having a blocking mode and an unblocking mode depending on an axial and/or rotational position of the filter element in the housing and being configured to provide access of the sealing structure of the filter element to a sealing area of the housing cover in the unblocking mode and to block access of the sealing structure of the filter element to the sealing area in the blocking mode when the sealing structure of the filter element is moved towards the sealing area. The safety assembly has a first section arranged at the housing and a second section arranged at the filter element, the first and second sections comprising at least one blocking element and at least one unblocking element configured to cooperate with the at least one blocking element. The at least one blocking element comprises an activation surface and the at least one unblocking element comprises a cam for pushing the activation surface in a radial direction when a contact between the cam and the activation surface is established.

The inventive filter system comprises a safety assembly for ensuring a correct and reliable mounting of the filter element to the housing of the filter system. The safety assembly comprises two sections where the first section is arranged at the housing and the second section is arranged at the filter element, preferably at an end cap of the filter element. The first section is arranged at the housing cover of the filter system. Both sections are cooperating when mounting the filter element to the housing.

The safety assembly is arranged inside the housing and has a blocking mode and an unblocking mode. The safety assembly may be switched from the blocking mode to the unblocking mode and vice versa depending on an axial and/or rotational position of the filter element in the housing. The safety assembly provides access of the sealing structure of the filter element to the sealing area of the housing cover in the unblocking mode and blocks access of the sealing structure of the filter element to the sealing area in the blocking mode.

Before mounting of the filter element to the housing the safety assembly is in the blocking mode where access of a sealing structure of the filter element to a sealing area of the housing cover is blocked by a blocking element. Connection of the sealing structure and the sealing area is needed for a proper sealing of a raw fluid region in the filter system against a filtered fluid region.

The sealing may favorably comprise a sealing area on an inner wall of the housing cover of the filter system for sealing a raw fluid region of the filter system against a filtered fluid region by interacting with the sealing structure of the filter element.

The access may be unblocked when a filter element with a corresponding unblocking element is mounted to the blocking element of the safety assembly. The blocking element may be realized by a construction cage with at least one spring member, whereas the unblocking element may be realized by a cam arranged at the end cap of the filter element, the cam cooperating with the spring member in an appropriate manner to unblock the sealing area. For this purpose, the cam may be arranged at the end cap protruding from the end cap along the longitudinal direction and pointing radially inwards.

In a favorable embodiment the blocking element may be arranged at the first section in the safety assembly arranged in the housing of the filter system, whereas the unblocking element may be arranged at the second section in the filter element. Yet, in another embodiment the blocking element may also be arranged at the second section in the filter element and the unblocking element may be arranged at the first section in the housing.

Favorably the safety assembly may also comprise facilities to fix the filter element to the safety assembly and thus to fix the filter element to the housing cover. This may be achieved by locking the end cap of the filter element to the blocking element of the safety assembly.

A further advantage of the inventive filter system is that no positioning of the filter element is needed due to some self-positioning structure and guiding grooves of the blocking element of the safety assembly. These structures lead the filter element during mounting in a longitudinal direction by a guiding rotation into the correct position in the housing. Further the filter element is led to an end position where it is fixed by the safety assembly in a locked position.

The fluid inlet as well as the fluid outlet may be favorably arranged in the housing head.

The safety assembly may favorably comprise a cage as a blocking element and at least one spring member. The safety assembly in mounted inside the housing cover of the housing of the filter system. The spring member has a blocking lip. The lip blocks access of the sealing structure of the filter element to the sealing area of the housing cover. To get access to the sealing area the spring member is bent by an unblocking element of the filter element with a special geometry, e.g., a cam radially oriented. A special labyrinth realized as a groove in the cage is used for guiding the unblocking element to unblock the access to the sealing area and also for pulling the filter element out of the housing cover. The system is preventing the use of a filter element without such an unblocking element, because the sealing area is blocked by the spring element.

Advantageously only a filter element with the appropriate geometry of the unblocking element may be assembled in the housing. Further the filter element may be pulled out of the housing during cover dismantling when the unblocking element is in an end position of the guiding groove thus locking the filter element inside the housing cover. The labyrinth in the blocking element favorably enables positioning of the sealing structure of the filter element to the sealing area of the housing. Further the safety assembly may favorably provide an open area for water drops running down due to water separator inside the filter element.

According to a favorable embodiment of the filter system, the blocking element may comprise at least one spring member comprising the activation surface and a radially protruding lip, wherein the lip is retractable from its blocking position by pushing the activation surface in a radial direction. The spring member may favorably realize the blocked mode where the lip is in protruded position and blocks an access to the sealing area of the housing cover. By pushing the activation surface in a radially inward direction the lip may be pushed back too, thus switching to the unblocked mode where access of the sealing structure of the filter element to the sealing area may be granted. The spring member may favorably be arranged in a horizontal position on at least part of the circumference of the safety assembly.

The blocking element may favorably be connected to the housing cover of the filter system.

According to a favorable embodiment of the filter system, the blocking element may comprise a positioning structure connected to a guiding groove which leads the unblocking element to the activation surface by a rotational movement when moving the filter element in the longitudinal direction towards the blocking element. A further advantage of the inventive filter system is that no positioning of the filter element is needed due to some self-positioning structure and guiding grooves of the blocking element of the safety assembly. These structures lead the filter element during mounting in a longitudinal direction by a guiding rotation into the correct position in the housing.

According to a favorable embodiment of the filter system, the blocking element may comprise a locking structure wherein the filter element is locked to the blocking element when the cam is inserted into the locking structure by a rotational movement of the filter element after surpassing the activation surface by the cam in the longitudinal direction. Favorably the safety assembly may also comprise facilities to fix the filter element to the safety assembly and thus to fix the filter element to the housing cover. This may be achieved by locking the end cap of the filter element to the blocking element of the safety assembly. Thus, the filter element is led to an end position where it is fixed by the safety assembly in a locked position.

According to a favorable embodiment of the filter system, the locking structure may comprise two ribs extending along opposite sides of the guiding groove. The cam may be locked between the two ribs in an axial direction of the filter element. Thus, a movement of the filter element along the longitudinal direction may favorably be inhibited.

According to a favorable embodiment of the filter system, in the unblocking mode access of the sealing structure of the filter element to the sealing area of the housing cover may be provided by the lip of the blocking element being retracted radially inward when the cam is moved to an end position by a rotational movement of the filter element after surpassing the activation surface by the cam in the longitudinal direction. Due to this further embodiment the end cap of the filter element may be locked by the blocking element thus fixing the filter element to the housing of the filter system. Thus, a movement of the filter element along the longitudinal direction may also be inhibited.

According to a favorable embodiment of the filter system, the filter element may be locked to the blocking element when the cam is moved to an end position by a rotational movement of the filter element after surpassing the activation surface by the cam in the longitudinal direction. Advantageously the end cap of the filter element may be locked by the blocking element thus fixing the filter element to the housing of the filter system. Thus, a movement of the filter element along the longitudinal direction may also be inhibited.

According to a favorable embodiment of the filter system, the at least one spring member may be arranged at least partly on a circumference of the blocking element, moving at least partly radially inward when the activation surface is pushed. This arrangement of the spring member enables a compact packaging of the filter system where the safety assembly may be arranged inside the end cap of the filter element when the end cap is locked to the safety assembly.

According to another aspect of the invention a safety assembly for a filter system is proposed, the filter system comprising a filter element and a housing. The safety assembly has a blocking mode and an unblocking mode depending on an axial and/or rotational position of the filter element in the housing and is configured to provide access of a sealing structure of the filter element to a sealing area of the housing in the unblocking mode and to block access of the sealing structure of the filter element to the sealing area in the blocking mode when the sealing structure of the filter element is moved towards the sealing area. The safety assembly has a first section arranged at the housing and a second section arranged at the filter element, the first and second sections comprising at least one blocking element and at least one unblocking element configured to cooperate with the at least one blocking element. The at least one blocking element comprises an activation surface and the at least one unblocking element comprises a cam for pushing the activation surface in a radial direction when a contact between the cam and the activation surface is established.

The safety assembly may favorably ensure a correct and reliable mounting of the filter element to the housing of the filter system. The safety assembly comprises two sections where the first section is arranged at the housing and the second section is arranged at the filter element, preferably at an end cap of the filter element. The first section is arranged at the housing cover of the filter system. Both sections are cooperating when mounting the filter element to the housing.

Before mounting of the filter element to the housing the safety assembly is in a blocking mode where access of a sealing structure of the filter element to a sealing area of the housing cover is blocked by a blocking element. Connection of the sealing structure and the sealing area is needed for a proper sealing of a raw fluid region in the filter system against a filtered fluid region.

The access may be unblocked when a filter element with a corresponding unblocking element is mounted to the blocking element. The blocking element may be realized by a construction cage with at least one spring member, whereas the unblocking element may be realized by a cam arranged at the end cap, the cam cooperating with the spring member in an appropriate manner to unblock the sealing area. For this purpose, the cam may be arranged at the end cap protruding from the end cap along the longitudinal direction and pointing radially inwards.

According to another aspect of the invention a filter element for a filter system is proposed, comprising a center pipe having a longitudinal direction and being surrounded by a filter bellows, the filter bellows comprising an end cap at one or both of its end regions, and comprising a section of a safety assembly with either at least one unblocking element or at least one blocking element configured to cooperate with either the at least one blocking element or the at least one unblocking element of a first section of the safety assembly. The filter element further comprises a sealing structure, particularly a gasket, on one of its end regions. The at least one blocking element and the at least one unblocking element are configured to provide access of the sealing structure to a sealing area of a housing cover of the filter system in the unblocking mode and to block access of the sealing structure to the sealing area in the blocking mode when the sealing structure is moved towards the sealing area.

Before mounting of the filter element to the housing of the filter system the safety assembly may be in a blocking mode where access of a sealing structure of the filter element to a sealing area of the housing cover is blocked by a blocking element. Connection of the sealing structure and the sealing area is needed for a proper sealing of a raw fluid region in the filter system against a filtered fluid region.

The access may be unblocked when the filter element with a corresponding unblocking element is mounted to the blocking element. The blocking element may be realized by a construction cage with at least one spring member, whereas the unblocking element may be realized by a cam arranged at the center pipe, the cam cooperating with the spring member in an appropriate manner to unblock the sealing area. For this purpose, the cam may be arranged at the end cap protruding from the end cap along the longitudinal direction and pointing radially inwards.

Favorably the filter element may also be fixed to the safety assembly and thus to the housing cover of the filter system. This may be achieved by locking the end cap of the filter element to the blocking element of the safety assembly.

The safety assembly is arranged inside the housing of the filter system and has a blocking mode and an unblocking mode. The safety assembly may be switched from the blocking mode to the unblocking mode and vice versa depending on an axial and/or rotational position of the filter element in the housing. The safety assembly provides access of the sealing structure of the filter element to the sealing area of the housing cover in the unblocking mode and blocks access of the sealing structure of the filter element to the sealing area in the blocking mode.

According to a favorable embodiment of the filter element, the at least one blocking element may comprise an activation surface and the at least one unblocking element may comprise a cam for pushing the activation surface in a radial direction when a contact between the cam and the activation surface is established.

The blocking element in the form of a spring member may favorably realize the blocked mode where a lip is in protruded position and blocks an access to the sealing area of the housing of the filter system. By pushing the activation surface in a radially inward direction the lip may be pushed back too, thus switching to the unblocked mode where access of the sealing structure of the filter element to the sealing area may be granted.

According to a favorable embodiment of the filter element, the unblocking element may comprise at least one cam arranged at the end cap parallel to the longitudinal direction pointing radially inwards. Thus, by moving the filter element in the longitudinal direction the cam at the end cap of the filter element gets into contact with the activation surface of the blocking member which is positioned inside the housing cover. The cam pushes the activation surface radially inwards and unblocks the access to the sealing area of the housing cover.

According to a favorable embodiment of the filter element, the blocking element may comprise at least one spring member comprising the activation surface and a radially protruding lip, wherein the lip is retractable from its blocking position by pushing the activation surface in a radial direction. The spring member may favorably realize the blocked mode where the lip is in protruded position and blocks an access to the sealing area of the housing cover. By pushing the activation surface in a radially inward direction the lip may be pushed back too, thus switching to the unblocked mode where access of the sealing structure of the filter element to the sealing area may be granted.

### BRIEF DESCRIPTION OF THE DRAWINGS

The present invention together with the above-mentioned and other objects and advantages may best be understood from the following detailed description of the embodiments, but not restricted to the embodiments, wherein is shown in:

FIG. 1 a cut view through a filter system with a safety assembly and a filter element according to an embodiment of the invention;

FIG. 2 a cut view through the filter element of the filter system of FIG. 1 connected to the blocking element;

FIG. 3 a perspective view of the filter element of FIG. 1;

FIG. 4 a side view of an end cap of the filter element of FIG. 3;

FIG. 5 a perspective view of a first section of the safety assembly of FIG. 1;

FIG. 6 a perspective view of parts of the first section of the safety assembly of FIG. 1;

FIG. 7 a perspective view of a spring member of the safety assembly of FIG. 6; and

FIGS. 8 to 17 successive steps of an interaction of the sections of the safety assembly during mounting of the filter element in perspective and cut views.

### DETAILED DESCRIPTION OF THE DRAWINGS

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

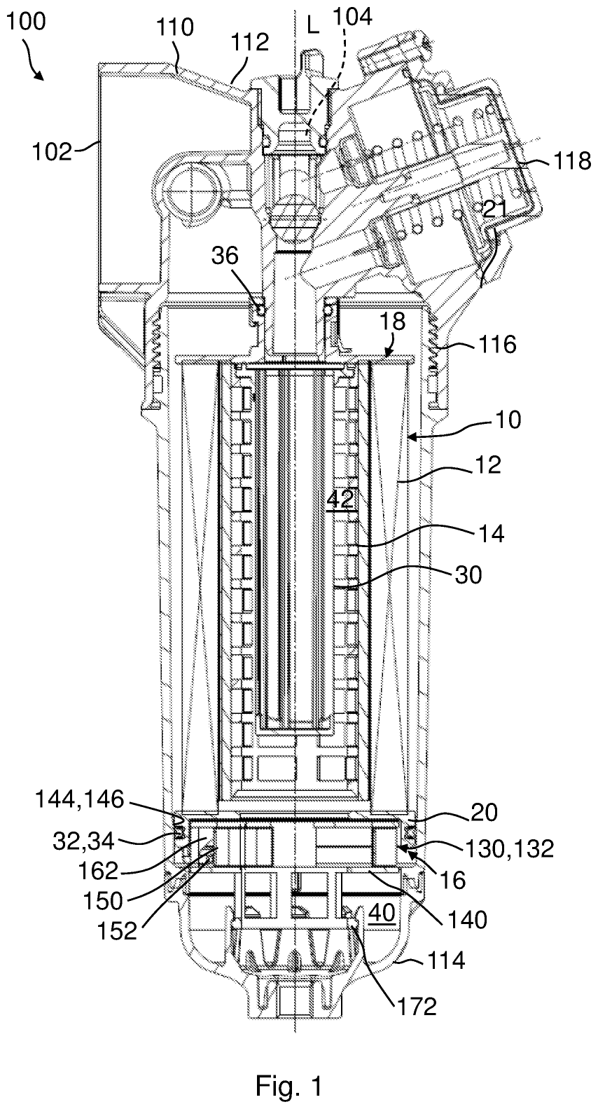

FIG. 1 depicts a cut view through a filter system 100 with a safety assembly 130 and a filter element 10 according to an embodiment of the invention.

The filter system 100 comprises a housing 110 with a housing head 112 and a housing cover 114, a fluid inlet 102 and a fluid outlet 104 and a filter element 10 being accommodated in the housing 110. The filter system 100 may be used for filtering fluids, particularly for motor oil. The filter element 10 is mounted to the housing cover 114 and then the housing cover 114 with the filter element 10 is mounted to the housing head 112 by inserting it into the housing head 112. The housing 110 is closed by tightening the screw connection 116. A fluid inlet 102 is arranged in the housing head 112 as well as a fluid outlet 114, which is not visible in the Figure. Also, a hand pump 118 is arranged in the filter head 112 for conveying fuel after maintenance action.

The filter element 10 separates a raw fluid region 40 inside the housing 110 from a filtered fluid region 42 by being sealed on the first end cap with the gasket 34 against the sealing surface 146 of the sealing area 144 of the housing cover 114 and on the other end cap 21 with the gasket 36 against the fluid outlet 104 in the housing head 112.

Fluid to be filtered enters the housing 110 of the filter system 100 through the fluid inlet 102, passes the filter bellows 12 from the raw fluid region 40 on the outside of the filter element 10 to the filtered fluid region 42 on the inside of the filter element 10. The filtered fluid exits the housing 110 through the fluid outlet 104. Fluid inlet 102 and fluid outlet 104 are both arranged in the housing head 112.

For changing the filter element 10 due to maintenance action the housing cover 114 is unscrewed and dismounted from the housing head 112 together with the filter element 10.

The filter element 10 comprises a center pipe 14 having a longitudinal direction L and being surrounded by a filter bellows 12. A water separator 30 is arranged inside the center pipe 14.

The filter bellows 12 comprises an end cap 20, 21 at one or both of its end regions 16, 18. The filter element 10 further comprises a sealing structure 32 with a gasket 34 at the end cap 20 for sealing against an inner wall of the housing cover 114, whereas a second gasket 36 is provided at the other end cap 21 for sealing against the fluid outlet 104 of the housing head 112.

The safety assembly 130 is arranged inside the housing 110 and exhibits a blocking mode and an unblocking mode depending on an axial and/or rotational position of the filter element 10 in the housing 110. The safety assembly 130 is configured to provide access of the sealing structure 32 of the filter element 10 to a sealing area 144 of the housing cover 114 in the unblocking mode and to block access of the sealing structure 32 of the filter element 10 to the sealing area 144 in the blocking mode when the sealing structure 32 of the filter element 10 is moved towards the sealing area 144.

The safety assembly 130 has a first section 132 arranged at the housing 110 and a second section 134 arranged at the filter element 10. The first section 132 comprises a blocking element 140. The second section 134 comprises an unblocking element 180 configured to cooperate with the blocking element 140. The blocking element 140 comprises an activation surface 148. The unblocking element 180 comprises a cam 188 for pushing the activation surface 148 in a radial direction when a contact between the cam 188 and the activation surface 148 is established.

The blocking element 140 comprises two spring members 150 comprising the activation surface 148 and a radially protruding lip 152, wherein the lip 152 is retractable from its blocking position by pushing the activation surface 148 in a radial direction. The blocking element 140 is fixed to the housing cover 114 by mounting members 172 which are extended in the longitudinal direction L and arranged in a circumference at a radial distance from the axis L.

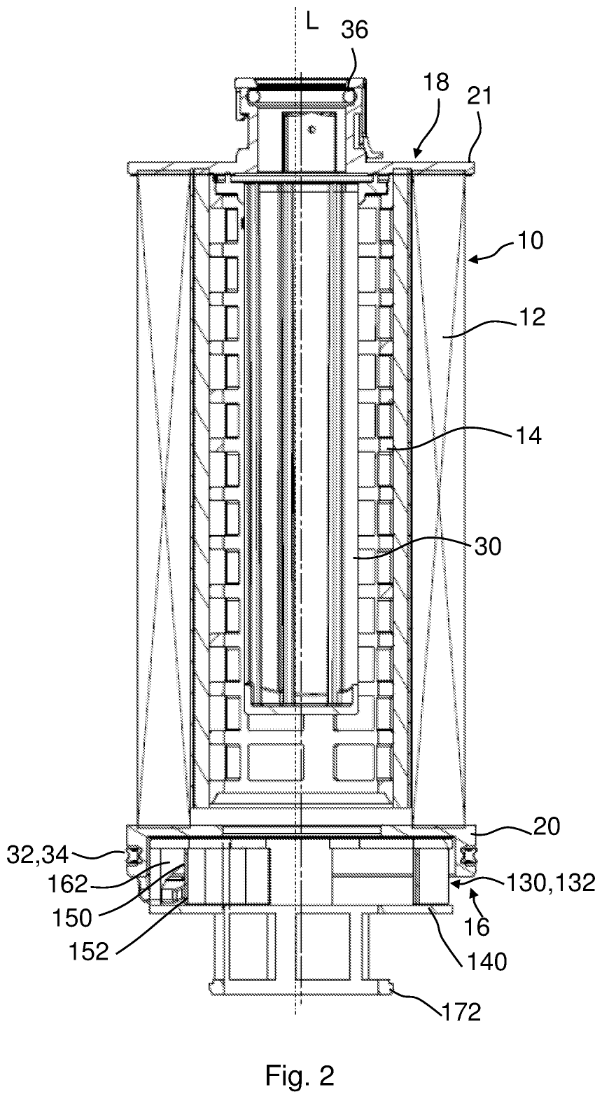

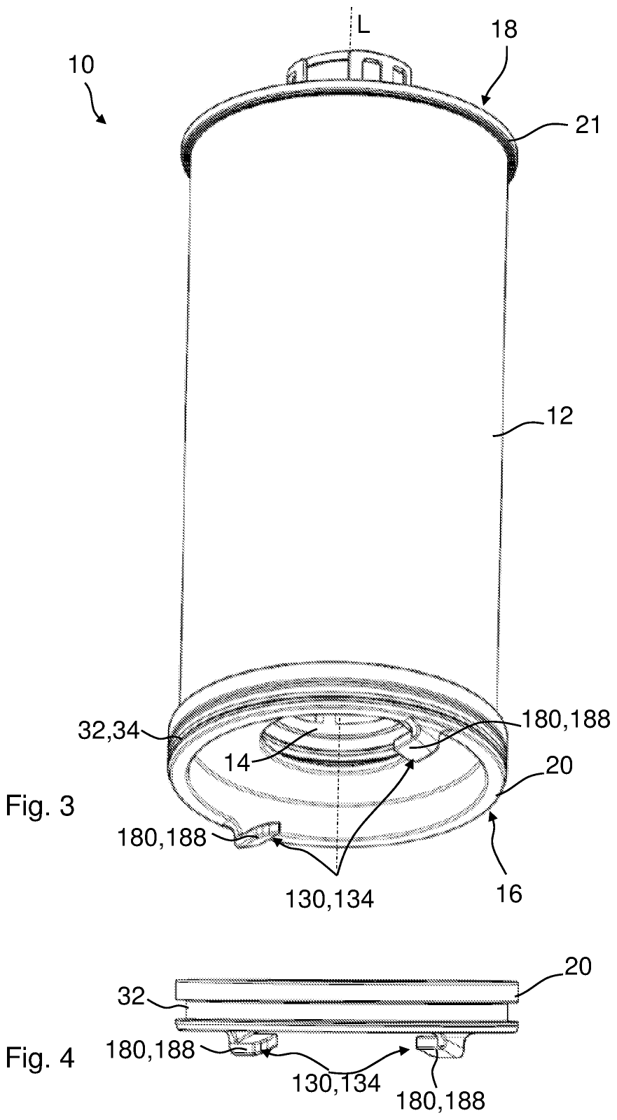

FIG. 2 depicts a cut view through the filter element 10 of the filter system 100 connected to the blocking element 140 as the first section 132 of the safety assembly 130. FIG. 3 depicts a perspective view of the filter element 10, whereas in FIG. 4 a side view of the end cap 20 of the filter element 10 is shown.

The safety assembly 130 has a blocking mode and an unblocking mode depending on an axial and/or rotational position of the filter element 10 in the housing 110. The safety assembly 130 is configured to provide access of a sealing structure 32 of the filter element 10 to a sealing area 144 of the housing 110 in the unblocking mode and to block access of the sealing structure 32 of the filter element 10 to the sealing area 144 in the blocking mode when the sealing structure 32 of the filter element 100 is moved towards the sealing area 144.

The safety assembly 130 has the first section 132 arranged at the housing 110 and the second section 134 arranged at the filter element 10 (as shown in FIGS. 3 and 4). The first section 132 comprises the blocking element 140 and the second section 134 comprises two unblocking elements 180 configured to cooperate with the blocking element 140. The unblocking elements 180 comprise a cam 188 arranged at the end cap 20 parallel to the longitudinal direction L pointing radially inwards. The two cams 188 are positioned across the end cap 20 opposite to each other.

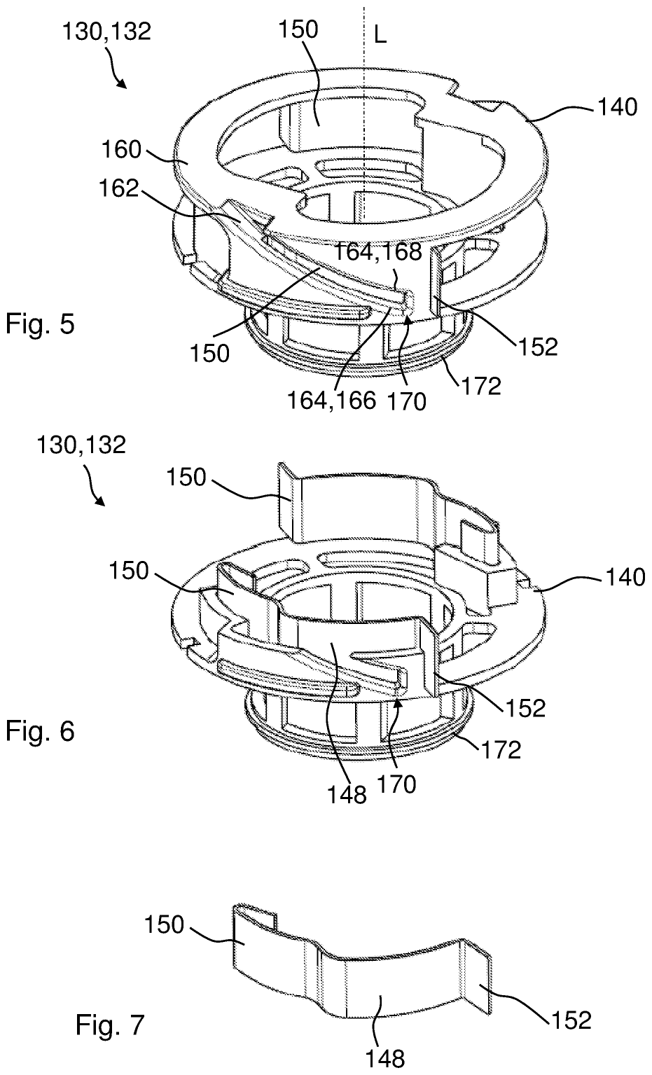

In FIG. 5 a perspective view of a first section 132 of the safety assembly 130 is depicted, whereas in FIG. 6 a perspective view of parts of the first section 132 of the safety assembly 130 is shown. In FIG. 7 a perspective view of a spring member 150 of the safety assembly 130 of FIGS. 5 and 6 is depicted.

The blocking element 140 comprises two spring members 150 arranged at least partly on a circumference of the blocking element 140. The spring members 150 comprise the activation surface 148 and the lip 152 radially protruding in the blocking mode of the safety assembly 130, thus preventing access of the sealing structure 32 of the end cap 20 to the sealing area 144 of the housing cover 114. The lip 152 is at least partly radially inward retractable from its blocking position by pushing the activation surface 148 in a radial direction.

The blocking element 140 thus comprises the activation surface 148. The unblocking element 180 (FIGS. 3 and 4) comprises the cam 188 for pushing the activation surface 148 in a radial direction when a contact between the cam 188 and the activation surface 148 is established.

The blocking element 140 is realized as a cage and comprises a positioning structure 160 connected to a guiding groove 162 which leads the unblocking element 180 to the activation surface 148 by a rotational movement when moving the filter element 10 in the longitudinal direction L towards the blocking element 140.

The blocking element 140 further comprises a locking structure 164 wherein the filter element 10 is locked to the blocking element 140 when the cam 188 is inserted into the locking structure 164 by a rotational movement of the filter element 10 after surpassing the activation surface 148 by the cam 188 in the longitudinal direction L. The locking structure 164 comprises two neighbored ribs 166, 168 extending opposite sides of the guiding groove 162. The filter element 10 is locked to the blocking element 140 when the cam 188 is moved to an end position 170 of the guiding groove 162 by a rotational movement of the filter element 10 after surpassing the activation surface 148 by the cam 188 in the longitudinal direction L.

In the unblocking mode access of the sealing structure 32 of the filter element 10 to the sealing area 144 of the housing cover 114 is provided when the lips 152 of the two spring members 150 of the blocking element 140 are retracted radially inward. When the cams 188 are moved to an end position 170 by a rotational movement of the filter element 10 and push the activation surfaces 148 radially inward by a rotational and translational movement in the longitudinal direction L the lips 152 are retracted and access is provided.

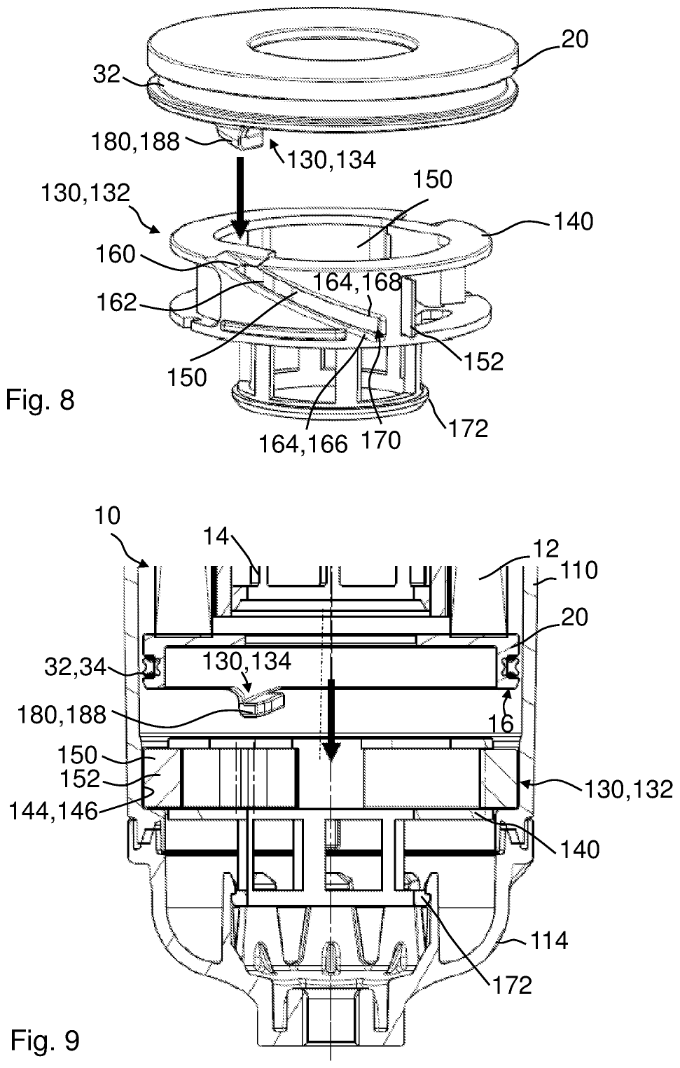

In FIGS. 8 to 17 successive steps of an interaction of the sections 132, 134 of the safety assembly 130 during mounting of the filter element 10 are depicted in perspective and cut views. The filter element 10 is represented by its end cap 20 and the two opposing cams 188 in order to get a free view on the interaction behavior of the different elements.

The process starts in FIG. 8 where the end cap 20 is depicted above the blocking element 140. The blocking element 140 is fixed to the housing cover 114 by the mounting members 172, as shown in FIG. 9.

By lowering the end cap 20 down on the blocking element 140 the cams 188 are led via the positioning structure 160 to the guiding grooves 162 of the blocking element 140. The spring members 150 are in its starting position where the lips 152 are protruded to the inner wall of the housing cover 114 and block the access of the sealing structure 32 at the end cap 20 (depicted without the gasket 34) to the sealing area 144 of the housing cover, as shown in FIG. 9.

The movement of the filter element 10 is indicated by arrows.

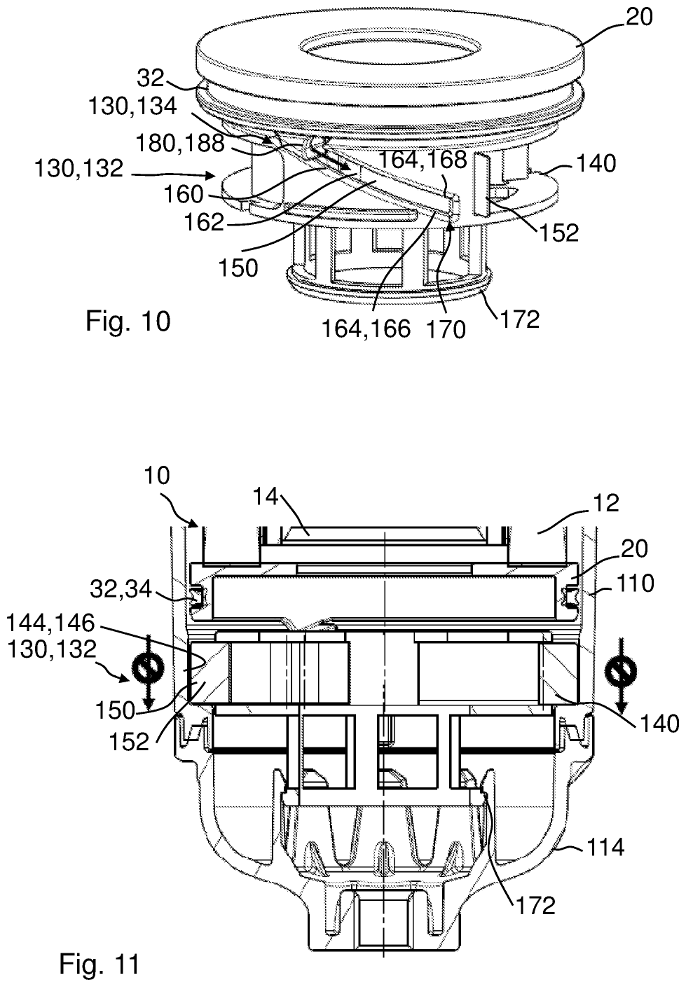

In FIG. 10 the cams 188 at the end cap 20 are inserted into the guiding grooves 162. The lips 152 of the spring member 150 are still protruded thus preventing access of the sealing structure 32 to the sealing area 144 of the housing cover 114, as shown in FIG. 11. This is indicated in FIG. 11 by a prohibition sign.

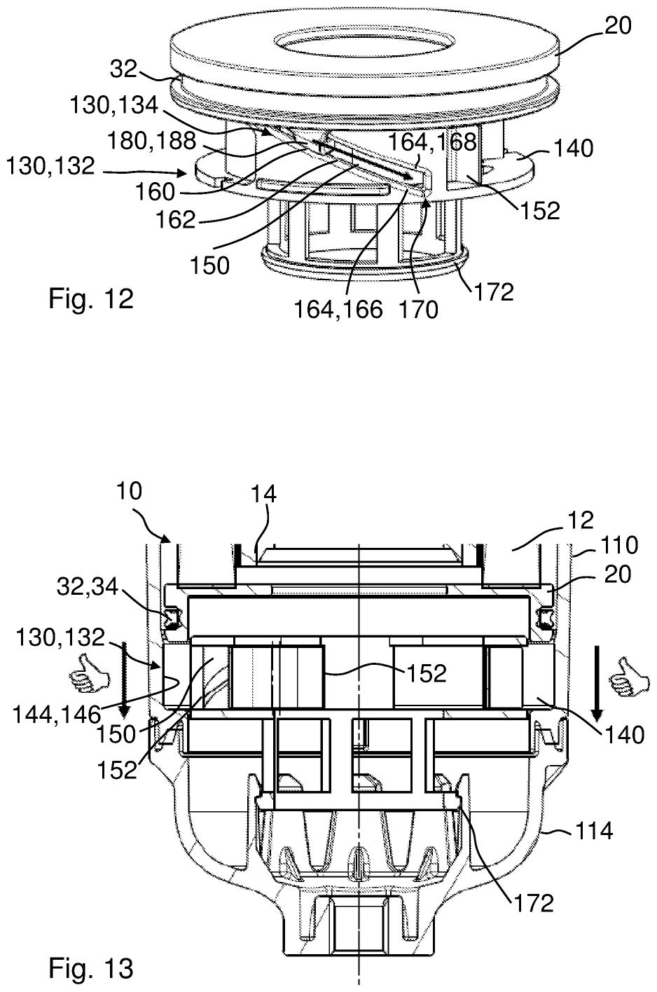

By moving the filter element 10 in the longitudinal direction L to the blocking element 140 thus performing a rotational movement of the end cap 20 together with the filter element 10 the cams 188 are guided in the guiding grooves 162 to the activation surfaces 148 of the spring members 150, as shown in FIG. 12.

As may be seen in FIGS. 12 and 13, the lips 152 of the spring member 150 are retracted radially inward thus enabling to further lower the filter element 10 down onto the blocking element 140 and gaining access to the sealing area 144. In FIG. 13 access is indicated by an acceptance sign.

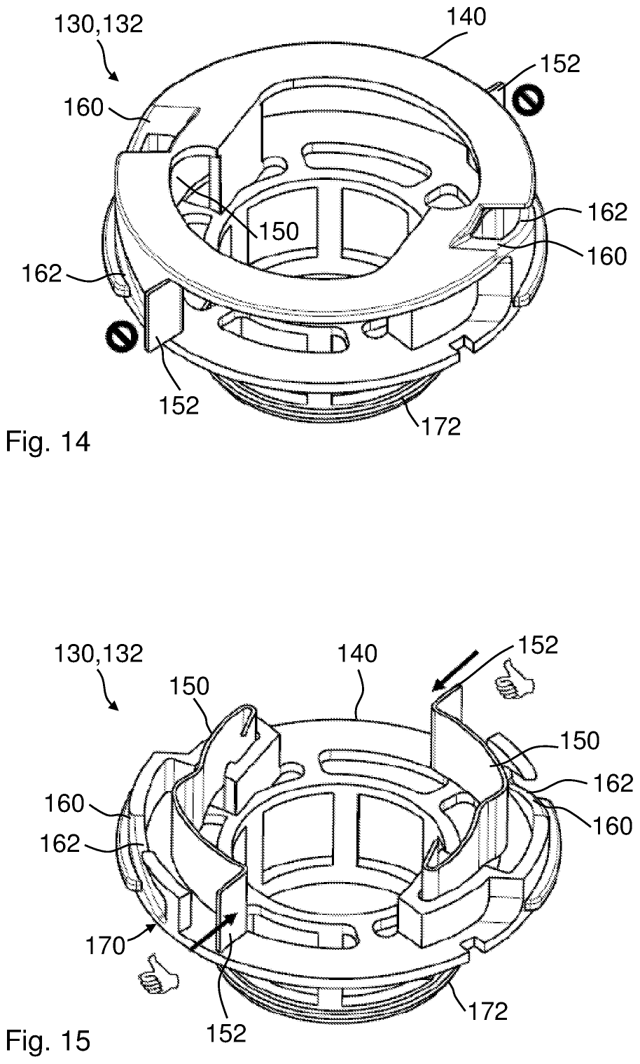

In FIG. 14 the blocking element 140 is still shown in the blocking mode where the lips 152 of the spring members 150 are protruding radially outward from the circumference of the blocking element 140, indicated by the prohibition sign.

In FIG. 15 the blocking element 140 is depicted in the unblocking mode where the lips 152 are retracted radially inward thus providing access to the sealing area 144, indicated by the acceptance sign.

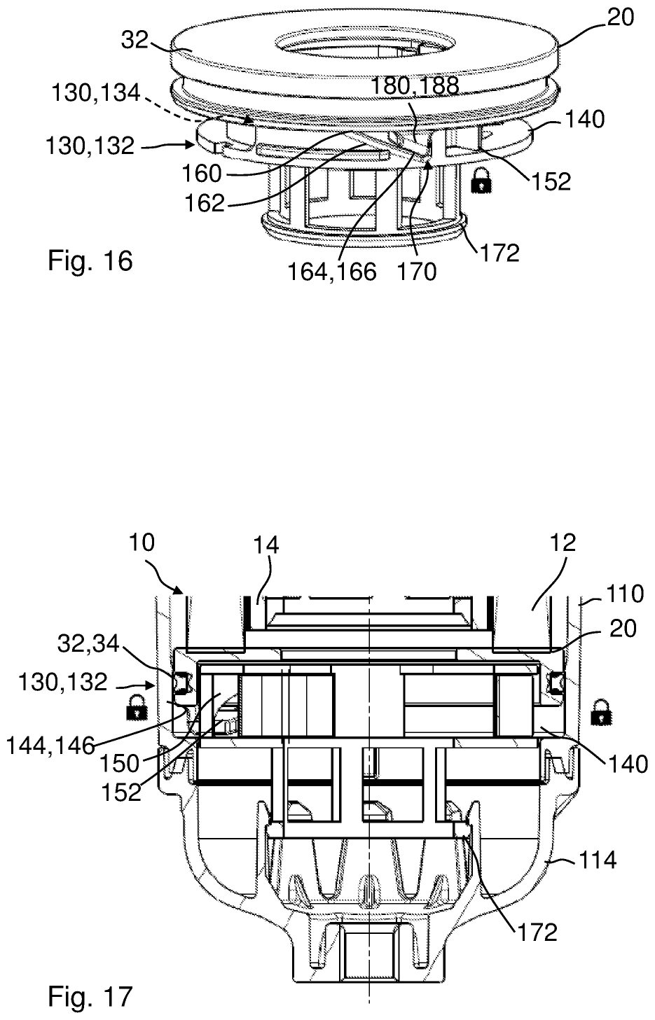

FIG. 16 depicts the blocking element 140 with the cams 188 as unblocking elements 180 in the locked position, indicated by a lock sign. The activation surfaces 148 of the spring members 150 are pushed radially inward. The cams 188 are in their end positions 170 locking the end cap 20 and thus the filter element 10 to the blocking element 140. As the blocking element 140 is fixed to the housing cover 114 by the mounting members 172 the filter element 10 is locked to the housing cover 114 by this way, as shown by FIG. 17. Thus, when dismantling the housing cover 114 from the housing head 112 of the filter system 100 the filter element 10 may be pulled out of the housing 110 by the housing cover 114.

### REFERENCE NUMERALS

10 filter element
12 filter bellows
14 center pipe
16 end region
18 end region
20 end cap
21 end cap
30 water separator
32 sealing structure
34 gasket
36 gasket
40 raw fluid region
42 filtered fluid region
100 filter system
102 fluid inlet
104 fluid outlet
110 housing
112 housing head
114 housing cover
116 screw connection
118 hand pump
130 safety assembly
132 first section
134 second section
140 blocking element
144 sealing area
146 sealing surface
148 activation surface
150 spring member
152 lip
160 positioning structure
162 guiding groove
164 locking structure
166 rib
168 rib
170 end position
172 mounting member
180 unblocking element
188 cam
L longitudinal direction

1. A filter system comprising a housing with a housing head and a housing cover, a fluid inlet and a fluid outlet and a filter element being accommodated in the housing,
the filter element comprising a center pipe having a longitudinal direction and being surrounded by a filter bellows, the filter bellows comprising an end cap at one or both of its end regions, the filter element further comprising a sealing structure, particularly a gasket, at the end cap,
wherein a safety assembly is arranged inside the housing, having a blocking mode and an unblocking mode depending on an axial and/or rotational position of the filter element in the housing and being configured to provide access of the sealing structure of the filter element to a sealing area of the housing cover in the unblocking mode and to block access of the sealing structure of the filter element to the sealing area in the blocking mode when the sealing structure of the filter element is moved towards the sealing area,
the safety assembly having a first section arranged at the housing and a second section arranged at the filter element, the first and second sections comprising at least one blocking element and at least one unblocking element configured to cooperate with the at least one blocking element,
the at least one blocking element comprising an activation surface and the at least one unblocking element comprising a cam for pushing the activation surface in a radial direction when a contact between the cam and the activation surface is established.

2. The filter system according to claim 1, wherein the blocking element comprises at least one spring member comprising the activation surface and a radially protruding lip, wherein the lip is retractable from its blocking position by pushing the activation surface in a radial direction.

3. The filter system according to claim 1 or 2, wherein the blocking element comprises a positioning structure connected to a guiding groove which leads the unblocking element to the activation surface by a rotational movement when moving the filter element in the longitudinal direction towards the blocking element.

4. The filter system according to any one of the preceding claims, wherein the blocking element comprises a locking structure, wherein the filter element is locked to the blocking element when the cam is inserted into the locking structure by a rotational movement of the filter element after surpassing the activation surface by the cam in the longitudinal direction.

5. The filter system according to claim 4, wherein the locking structure comprises two ribs extending along opposite sides of the guiding groove.

6. The filter system according to any one of the claims 2 to 5, wherein in the unblocking mode access of the sealing structure of the filter element to the sealing area of the housing cover is provided by the lip of the blocking element being retracted radially inward when the cam is moved to an end position by a rotational movement of the filter element after surpassing the activation surface by the cam in the longitudinal direction.

7. The filter system according to any one of the preceding claims, wherein the filter element is locked to the blocking element when the cam is moved to an end position by a rotational movement of the filter element after surpassing the activation surface by the cam in the longitudinal direction.

8. The filter system according to any one of the claims 2 to 7, wherein the at least one spring member is arranged at least partly on a circumference of the blocking element, moving at least partly radially inward when the activation surface is pushed.

9. A safety assembly for a filter system according to any one of the preceding claims, the filter system comprising a filter element and a housing,
having a blocking mode and an unblocking mode depending on an axial and/or rotational position of the filter element in the housing and
being configured to provide access of a sealing structure of the filter element to a sealing area of the housing in the unblocking mode and to block access of the sealing structure of the filter element to the sealing area in the blocking mode when the sealing structure of the filter element is moved towards the sealing area,
having a first section arranged at the housing and a second section arranged at the filter element, the first and second sections comprising at least one blocking element and at least one unblocking element configured to cooperate with the at least one blocking element,
the at least one blocking element comprising an activation surface and the at least one unblocking element comprising a cam for pushing the activation surface in a radial direction when a contact between the cam and the activation surface is established.

10. A filter element for a filter system according to any one of the claims 1 to 8, comprising a center pipe having a longitudinal direction and being surrounded by a filter bellows, the filter bellows comprising an end cap at one or both of its end regions, and comprising a section of a safety assembly with either at least one unblocking element or at least one blocking element configured to cooperate with either the at least one blocking element or the at least one unblocking element of a first section of the safety assembly, the filter element further comprising a sealing structure, particularly a gasket, on one of its end regions,
wherein the at least one blocking element and the at least one unblocking element are configured to provide access of the sealing structure to a sealing area of a housing cover of the filter system in the unblocking mode and to block access of the sealing structure to the sealing area in the blocking mode when the sealing structure is moved towards the sealing area.

11. The filter element according to claim 10, wherein the at least one blocking element comprises an activation surface and the at least one unblocking element comprises a cam for pushing the activation surface in a radial direction when a contact between the cam and the activation surface is established.

12. The filter element according to claim 10 or 11, wherein the unblocking element comprises at least one cam arranged at the end cap parallel to the longitudinal direction pointing radially inwards.

13. The filter element according to any one of the claims 10 to 12, wherein the blocking element comprises at least one spring member comprising the activation surface and a radially protruding lip, wherein the lip is retractable from its blocking position by pushing the activation surface in a radial direction.
